(19) United States
(12) Patent Application Publication
(10) Pub. No.: US 2003/0033410 A1
(43) Pub. Date: Feb. 13, 2003

(54) Machine resource management system, method and program

(76) Inventor: Norihiro Kobayashi, Yokohama (JP)

Correspondence Address: MCDERMOTT, WILL & EMERY, 600 13th Street, N.W., Washington, DC, 20005-3096, US

(21) Appl. No.: 10/207,397

(22) Filed: Jul. 30, 2002

(30) Foreign Application Priority Data
Aug. 1, 2001 (JP) 2001-233777

(51) Int. Cl. G06F 15/173

(52) U.S. Cl. 709/225

(57) ABSTRACT

A resource management system is provided that activates inactivated managed terminals via a network to allow a manager terminal to manage managed terminals including out-of-use terminals. The resource management system includes a management database in which management information on a managed terminal connected to a resource management server is stored; an existence checking processing unit including a connection request unit that issues a request to connect to the managed terminal and sends a command file containing an activation request; and a connection acceptance unit that receives a result file containing a response to a command included in the command file; and a terminal status update unit that updates the management database based on contents notified by the result file. The system manages the managed terminals based on the information stored in the management database.

### BACKGROUND OF THE INVENTION

The present invention relates to a resource management system and a resource management method, and more particularly to a resource management system and a resource management method that manage machine hardware, such as terminals connected via a network, as resources.

As a computer system has become more distributed and larger recently, the management cost of the computer system has increased. To reduce the management cost, various systems have been proposed.

For example, JP-A-2000-298601 discloses a system that manages the operation status of a managed terminal by notifying the manager terminal of the activation and termination of the managed terminal when its power is turned on or off.

JP-A-11-27285 discloses a network management system allows three management systems, that is, network operation management system, configuration management system, and resource management system, to work together to simultaneously update management data in the three systems. AS a result, this system can match management data to the systems in actual operation.

Because the resource management system disclosed in JP-A-2000-298601 manages the operation status in synchronization with the activation and termination of a managed terminal, it is impossible to determine whether an inactive terminal is simply in out-of-use status for a certain period of time or it has been removed. Therefore, the manager must visit the installation location for confirming the status of the resource before updating the system configuration information of the resource management system.

The network management system disclosed in JP-A-11-27285 also requires the manager to judge whether or not the management information on an inactive managed terminal should be reflected on the system configuration information. To make the judgment, the manager must check the status of the terminal.

### SUMMARY OF THE INVENTION

In view of the foregoing, the present invention provides a resource management system that allows a manager terminal to manage managed terminals, including out-of-use terminals, by enabling the manager terminal to activate inactive managed terminals via a network.

To solve the above problem, the present invention employs the means described below.

A resource or asset management system includes a management database in which management information on a managed terminal connected to a resource or asset management server is stored; an existence checking processing unit including a connection request unit that issues a request to connect to the managed terminal and sends a command file containing an activation request; and a connection acceptance unit that receives a result file containing a response to a command included in the command file; and a terminal status update unit that updates the management database based on contents notified by the result file. The system manages the managed terminals based on the information stored in the management database.

### BRIEF DESCRIPTION OF THE DRAWINGS

FIG. 1 is a diagram showing an example of the configuration of computer systems to which a resource management system according to the present invention is applied.

FIG. 2 is a diagram showing an example of the configuration of a resource management server in an embodiment of the present invention.

FIG. 3 is a diagram showing an example of the configuration of a managed terminal.

FIG. 4 is a diagram showing an example of the configuration of a relay server.

FIG. 5 is a diagram showing an example of the configuration of the tables stored in a management database.

FIG. 6 is a diagram showing an example of management rule definitions.

FIG. 7 is a diagram showing an example of display on an output unit.

FIGS. 8A and B are diagrams showing an example of the configuration of control files.

FIG. 9 is an example of flowchart showing higher-level connection processing performed by the managed terminal.

FIG. 10 is an example of flowchart showing higher-level connection processing performed by the relay server.

FIG. 11 is an example of flowchart showing subordinate system existence checking processing performed by an existence checking unit.

FIG. 12 is an example of flowchart showing result notification file transmission processing performed by the existence checking unit.

FIG. 13 is an example of flowchart showing result reflection processing performed by a result reflection processing unit.

FIG. 14 is an example of flowchart showing terminal status update performed by a terminal status update unit.

FIG. 15 is an example of flowchart showing periodic checking processing performed by a time monitor unit.

FIG. 16 is an example of flowchart showing service management cooperation plug-in processing.

FIG. 17 is an example of flowchart showing mail plug-in processing.

### DESCRIPTION OF THE EMBODIMENTS

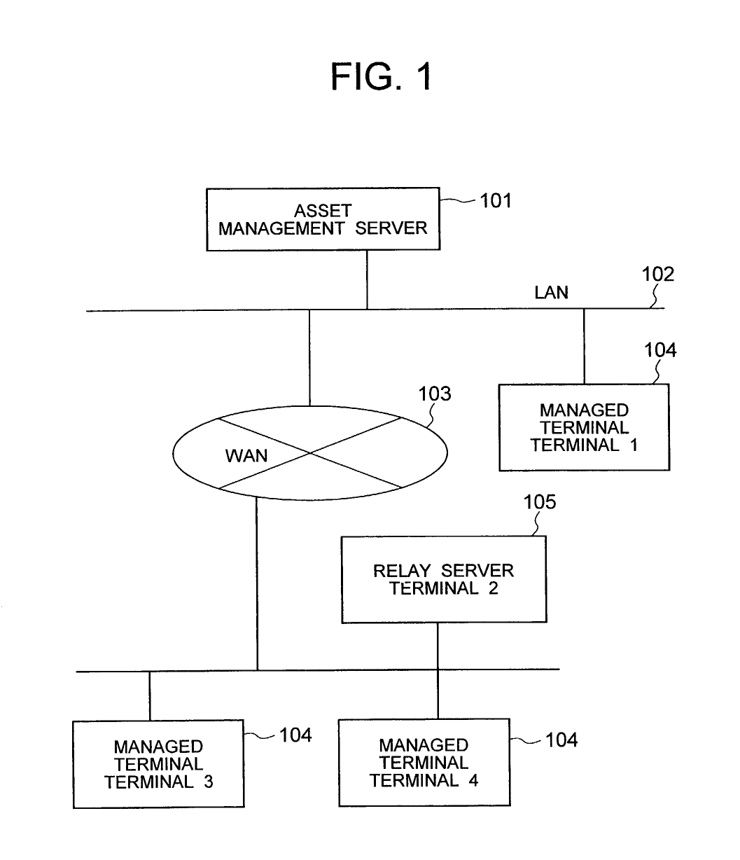

An embodiment of the present invention will be described in detail below with reference to the drawings. FIG. 1 is a diagram showing an example of the system configuration of computers to which a resource management system according to the present invention is applied. Referring to FIG. 1, the numeral 101 indicates a resource management server of the resource management system, the numeral 104 indicates managed terminals managed by the resource management server 101, and the numeral 105 indicates a relay server. The numeral 102 indicates a LAN (Local Area Network) and the numeral 103 indicates a WAN (Wide Area Network). Those networks interconnect the resource management server, managed terminals, and relay server. The relay server 105 is added when the network is large and, via the relay server 105, the managed terminal 104 is connected to the resource management server 101. In the following description, it is understood that the managed terminal 104 includes the relay server 105 unless otherwise stated.

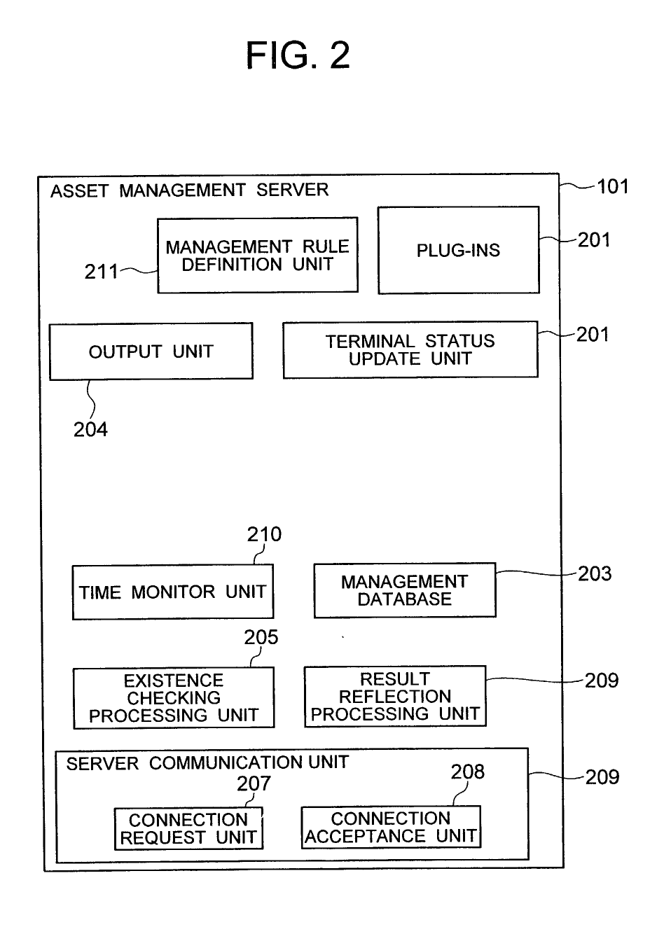

FIG. 2 is a diagram showing the configuration of the resource management server 101 used in the embodiment. Referring to figure, the numeral 201 indicates plug-ins (software programs for inclusion into particular applications such as a service management software program and a mail software program) and the numeral 202 indicates a terminal status update unit that updates resource information in a management database 203 based on information obtained from the plug-ins 201 and a management rule definition unit 211. The numeral 203 indicates a resource management database in which resource information on managed terminals that are resources, the system configuration information, and the status information on the managed terminals 104 are stored. The numeral 204 indicates an output unit that displays resource information and so on, stored in the management database 203, based on the definition information contained in the management rule definition unit. The numeral 205 indicates an existence checking unit that checks the operation status of a managed terminals via a server communication unit 206. The numeral 206 indicates a server communication unit via which a connection to a managed terminal is established. This unit comprises a connection request unit 207 that requests a connection to the managed terminal 104 and a connection acceptance unit 208 that accepts a response from the managed terminal to do response processing. The numeral 209 indicates a result reflection processing unit that reflects the result of the response processing on the management database 203. The numeral 210 indicates a time monitor unit that monitors an elapsed time. The numeral 211 indicates an management rule definition unit that comprises a status definition section in which the statuses of a terminal are defined, a display condition definition section in which the display conditions for displaying on the output unit are defined, and a plug-in definition section in which plug-ins are defined. As will be described later, the plug-in definition section comprises a status plug-in definition section and an execution plug-in definition section.

As shown in the figure, the resource management server 101 processes information in the management database 203 based on information in the management rule definition unit 211 and outputs the processing result on the output unit 204. The existence checking processing unit 205 inquires of each managed terminal 104 about its status via the server communication unit 206 based on the system configuration information stored in the management database 203. In addition, the existence checking processing unit updates the management database 203 via the result reflection processing unit 209 based on the inquiry result.

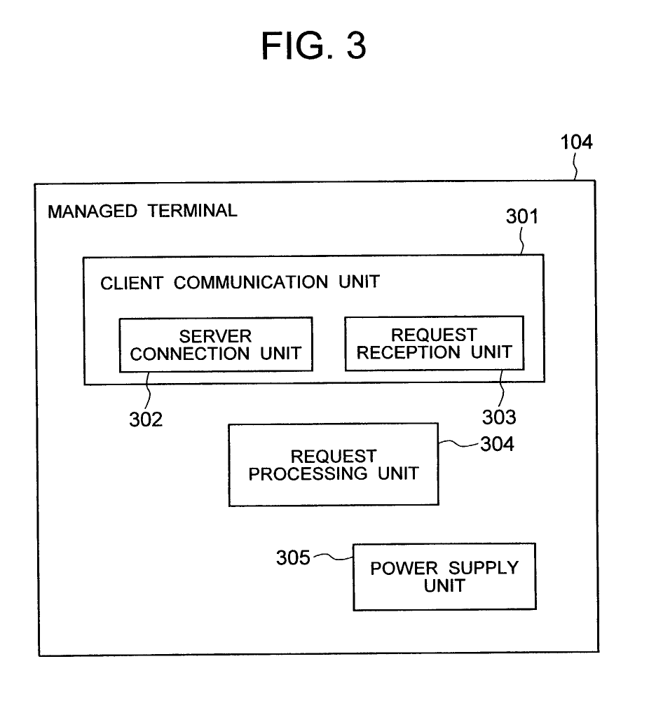

FIG. 3 is a diagram showing the configuration of the managed terminal 104. Referring to the figure, the numeral 301 indicates a client communication unit, the numeral 302 indicates a server connection unit used to connect to the resource management server or a relay server, the numeral 303 indicates a request reception unit that receives an activation request or a connection request from the resource management server, the numeral 304 indicates a request processing unit that processes the received request, and the numeral 305 indicates a power supply unit activated by the request acceptance unit.

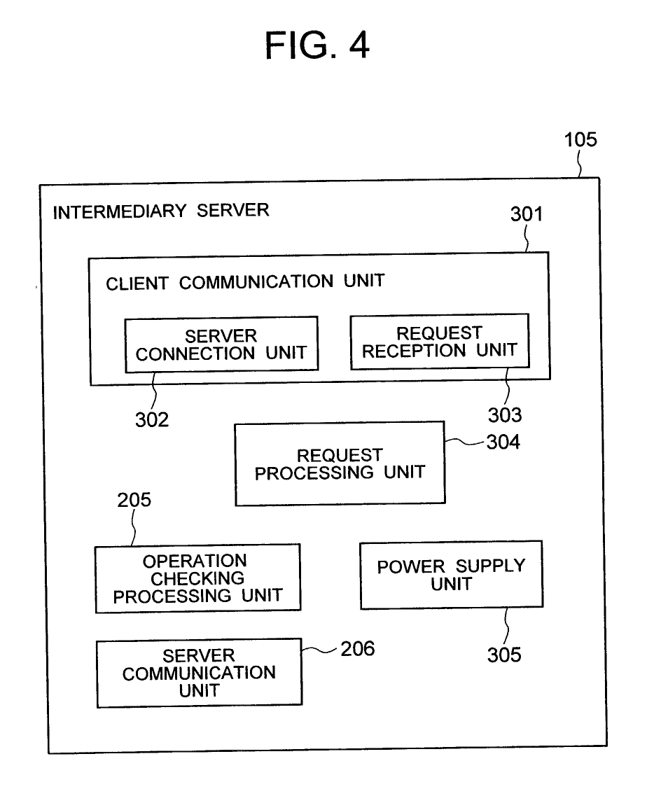

FIG. 4 is a diagram showing the configuration of a relay server. The relay server comprises the managed terminal shown in FIG. 3 (301-305), the existence checking unit 205 and the server communication unit 206 that sends or receives a request to or from the resource management server.

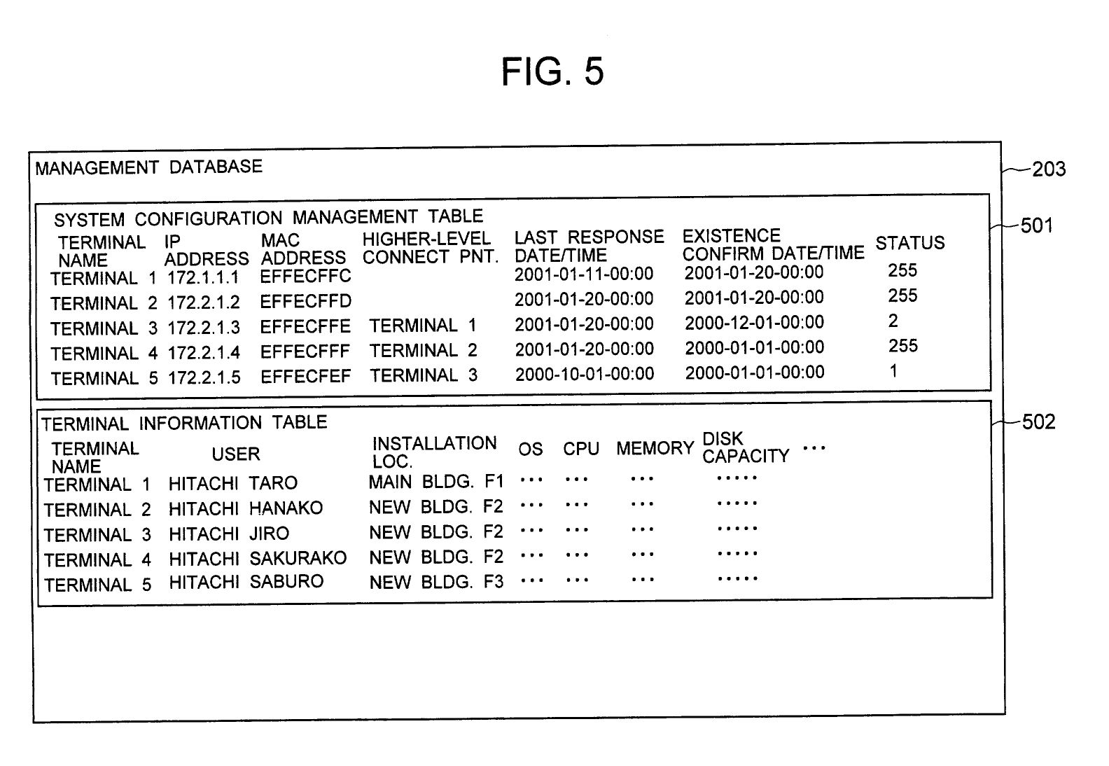

FIG. 5 is a diagram showing the structure of the tables stored in the management database 203. A system configuration management table 501 included in the management database comprises the following fields: communication related information fields containing the terminal name, IP address, and MAC address of a managed terminal, the higher-level connected-to point field containing the name of a higher-level connected-to point in the system configuration to which a managed terminal is to connect, the last-response date/time field containing the date and time at which a response from an activated terminal was confirmed, the existence confirm date/time at which an activation request was sent to a terminal to confirm that existence of the terminal, and the status field containing the terminal status finally decided by the information. A terminal information table 502 comprises the fields containing information on the user, installation location, OS name, memory, disk capacity, and other terminal information.

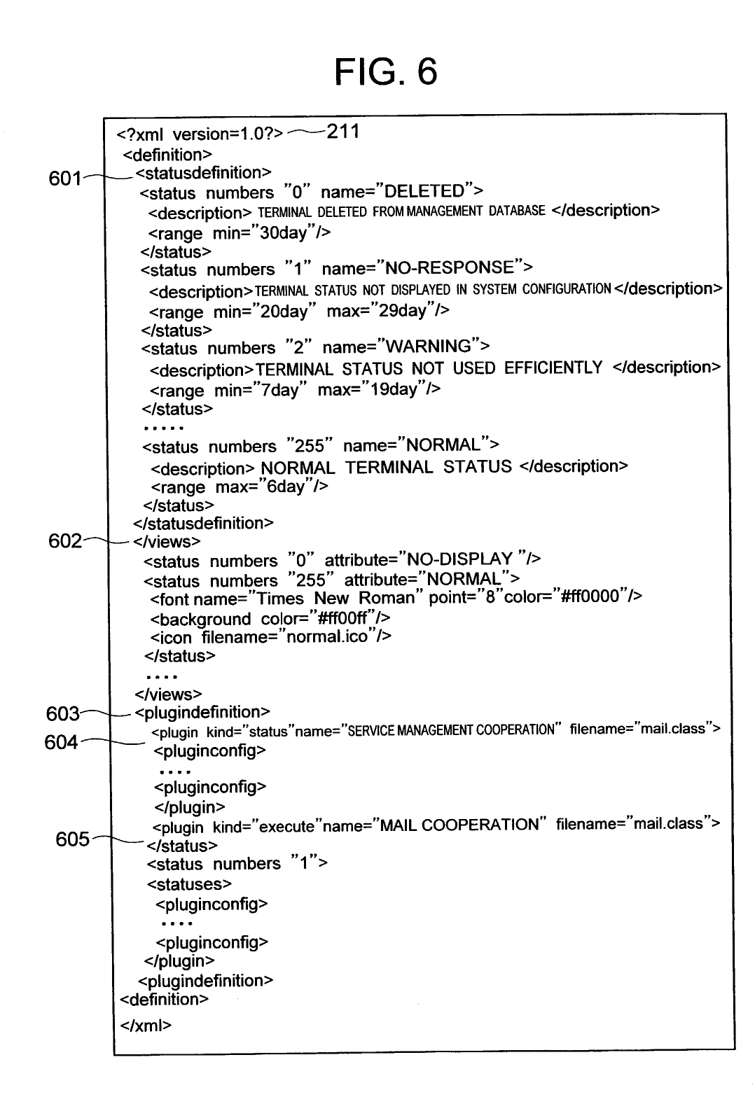

FIG. 6 is a diagram showing an example of definition included in the management rule definition unit 211. The management rule definition unit 211 comprises a status definition section 601, a display condition definition section 602, and a plug-in definition section 603.

The status definition section 601 defines the status of a terminal. The terminal status number ranges from 0 to 255; 0 indicates a deleted terminal and 1 indicates a no-response terminal. When the terminal is in the normal status, this value is 255. Each of the values, 2-254, represents one of user-defined warning statuses. Each of these statuses is defined as the status of a terminal in the period of time from the last response date/time or the existence confirm date/time stored in the management database to the current date/time.

The display condition definition section 602 defines the font, display color, background color, icon, and attributes (no-display, animation, blink, etc.) for each status and specifies the output format of each status on the output unit 204.

The plug-in definition section 603 is defined when plug-ins that work in corporation with an external system is used. There are two types of plug-in: one is a status plug-in that identifies the terminal status (defined by a status plug-in definition 604) and the other is an execution plug-in that is called when the status changes (defined by an execution plug-in definition 605). The plug-in name, file name, and plug-in specific definition information are defined for each of these plug-in types.

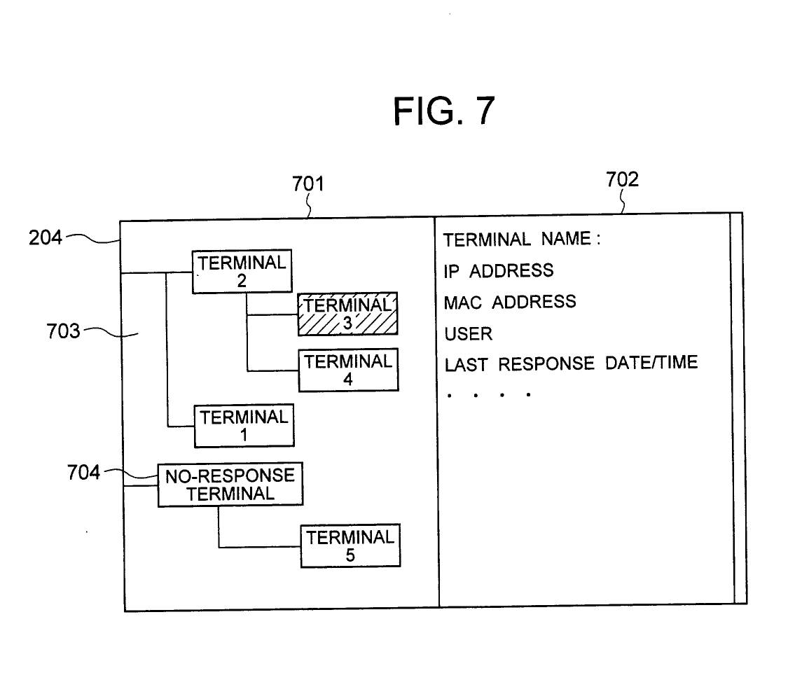

FIG. 7 is a diagram showing an example of display on the output unit 204 that displays the system status. In this example, the output unit comprises two screens. In a first screen 701, the managed terminals 104 are displayed as a system configuration tree 703 created based on the system connection configuration. In a second screen 702, information on the managed terminal 104 selected in the first screen 701 is displayed. That is, in the first screen 701, the terminals with different statuses are displayed according to the definition in the display condition definition section 602 so that they can be distinguished at a glance. A terminal, which is specified as a terminal with the no-display attribute in the display condition definition section 602, is displayed not in the system configuration tree 703 but in a no-response terminal tree 704.

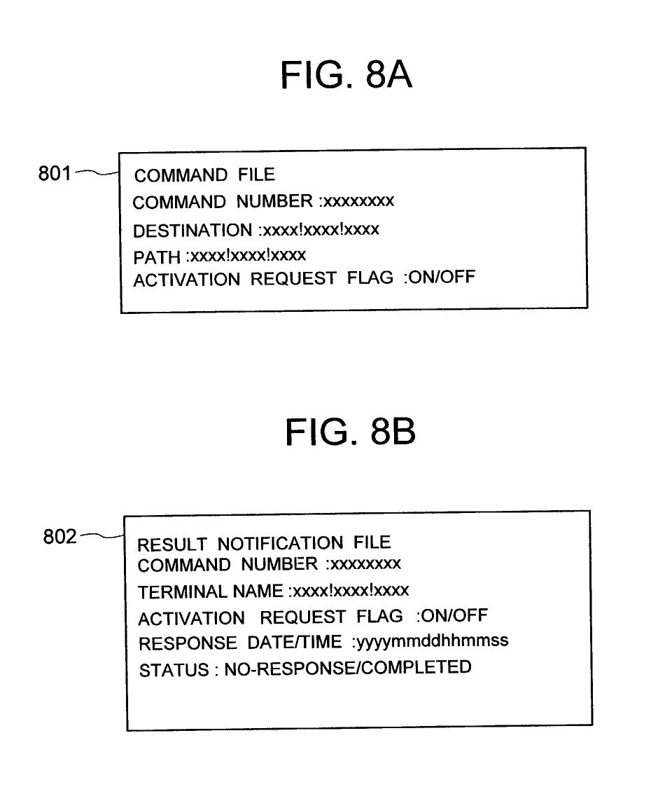

FIGS. 8A and 8B are diagrams showing the configuration of control files transferred between a server and a managed terminal. When the server is a resource management server, a command file 801 is created based on the information stored in the management database 203. When the server is a relay server, the command file 801 is created newly based on a command file received from the resource management terminal. The command file contains a unique command number, a destination specified by a communication path to a terminal to be checked, a path information path that has been sent, and an activation request flag indicating whether or not the terminal is activated via the network.

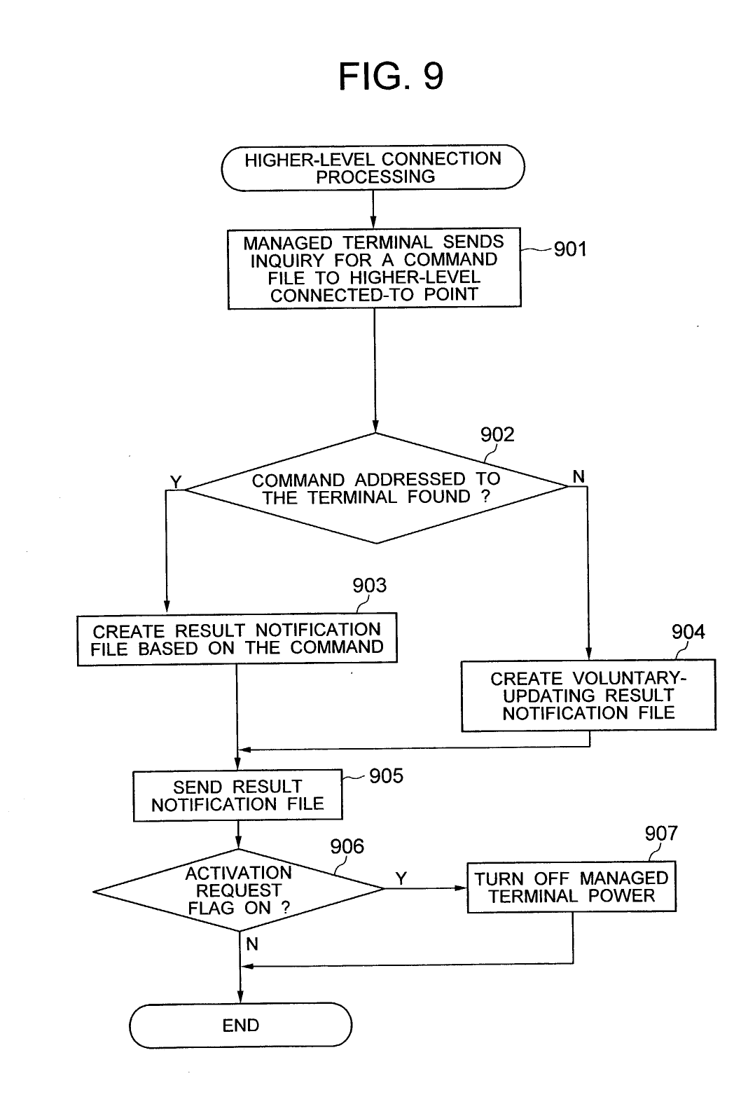

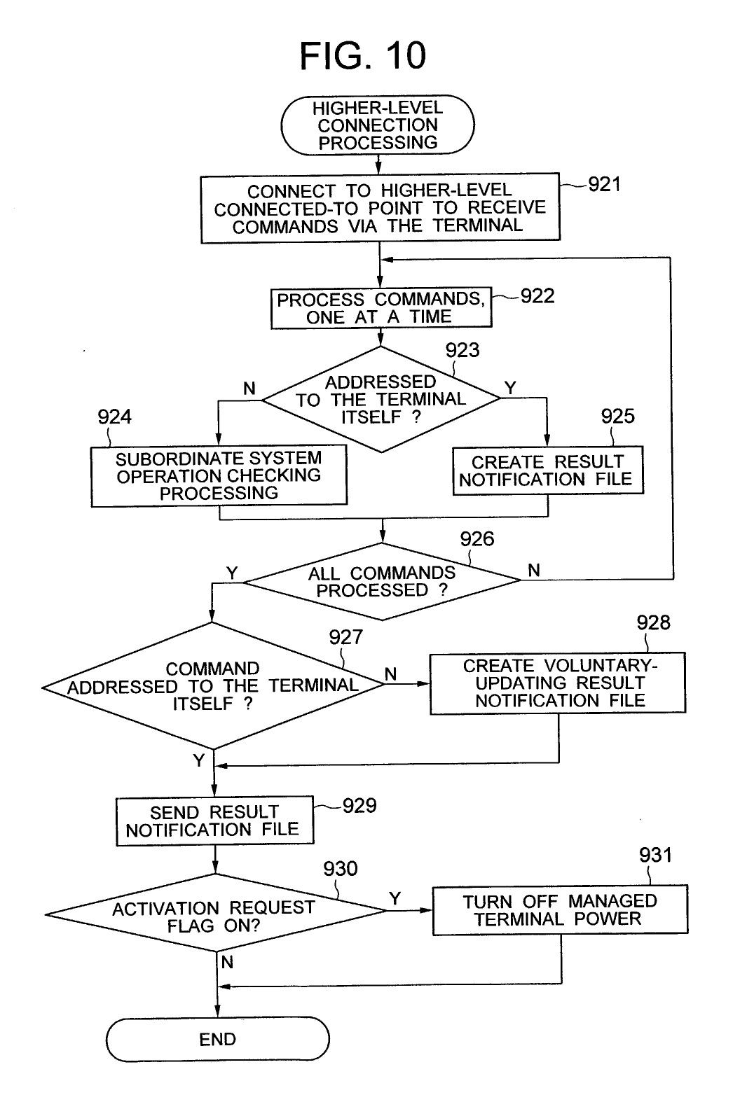

A result notification file 802 contains the command number of the corresponding command file 801, an activation request flag, a terminal name, a terminal status, and a response date/time. When the power supply unit 305 is turned on or when the request reception unit 303 receives a connection request from the higher-level connected-to point, the managed terminal 104 connects to a higher-level connected-to point according to the setting to perform higher-level connection processing according to the flowcharts shown in FIG. 9 or FIG. 10.

FIG. 9 is a diagram showing higher-level connection processing performed by the request processing unit 304 in the managed terminal 104 which is not included in the relay server 105. When the power supply unit 305 is turned on or when the request reception unit 303 receives a connection request from the higher-level connected-to point, the managed terminal 104 performs higher-level connection processing according to the processing flow shown in FIG. 9.

First, in step 901, the request processing unit 304 of the managed terminal sends an inquiry to the higher-level connected-to point via the server connection unit 302 and, in step 902, checks if there is the command file 801 addressed to the terminal. If such a command file is found, the request processing unit creates the result notification file 802 corresponding to the received command file 801 in step 903. If such a file is not found, the request processing unit creates the result notification file 802 in step 904 to voluntarily update the last response date/time. In the description below, this file is referred to as a voluntary-updating result notification file, which is one form of the result notification file.

In step 905, the request processing unit 304 sends the result notification file, created in step 903 or in step 904, to the higher-level connected-to point via the server connection unit 302. If it is found in step 906 that the activation request flag is set in the command file 801, the request processing unit 304 requests the power supply unit 305 to turn off the power of the terminal in step 907 and ends processing.

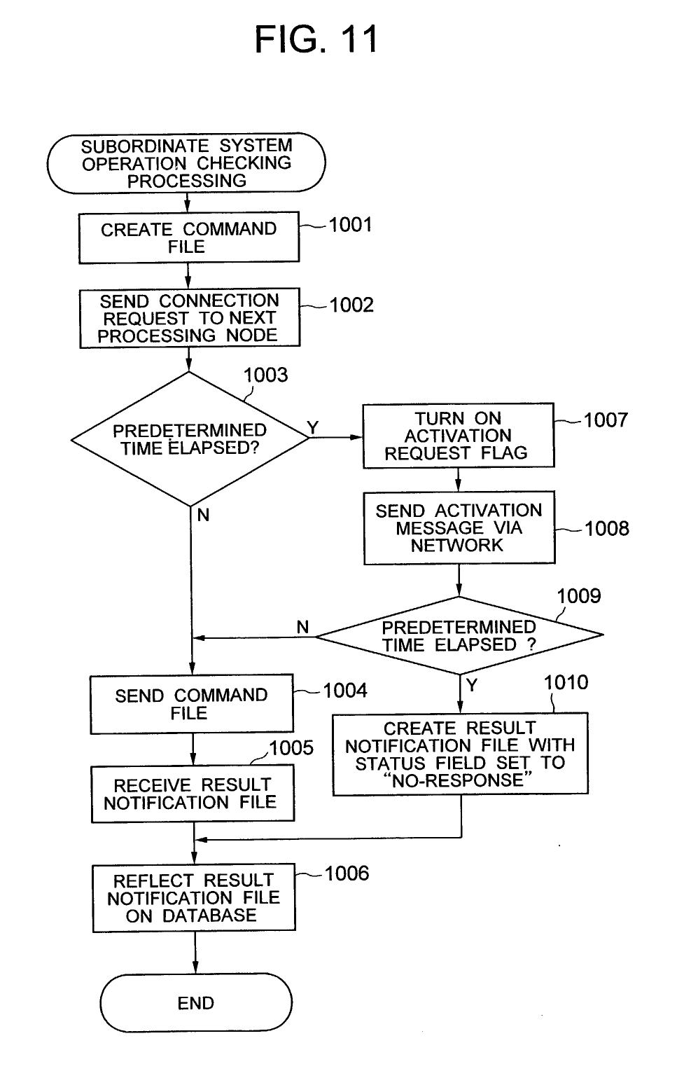

FIG. 10 is a diagram showing higher-level connection processing performed by the request processing unit 304 in the relay server 105. When the power supply unit is turned on or when the request reception unit 303 receives a connection request from the higher-level connected-to point, the managed terminal 104 performs higher-level connection processing according to the flowchart in the figure. First, in step 921, the request processing unit 304 sends an inquiry to the higher-level connected-to point via the server connection unit 302 to receive the command files 801 addressed to the terminal itself and to its subordinate terminals in the system configuration. In step 922, the command is processed (A plurality of command files 801, if received, are processed, one at a time). In step 923, the request processing unit checks if the command file 801 is addressed to the terminal itself and, if not, checks the operation of a subordinate system in step 924 according to the flowchart shown in FIG. 11.

If the command file 801 is addressed to the terminal itself, the request processing unit obtains the current date/time and terminal information in step 925 and creates the result notification file 802 corresponding to the command file 801. In step 926, the request processing unit checks if all commands have been processed and, if so, passes control to step 927. In step 927, the request processing unit 304 checks the received files if there is the command file 801 addressed to the terminal itself. If no file is addressed to the terminal itself, control is passed to step 928 to create a voluntary-updating result notification file 802.

In step 929, the request processing unit sends the result notification file 802, which was created in step 925 or step 928, to the higher-level connected-to point via the server connection unit 302. In step 930, the request processing unit performs the same processing as that in step 906. If the activation request flag in the command file 801 is set, the request processing unit passes control to step 931 and requests the power supply unit 305 to turn off the power of the terminal itself in step 931 to terminate processing.

FIG. 11 is a flowchart showing subordinate system existence checking processing performed by the existence checking processing unit 205.

First, in step 1001, the existence checking processing unit 205 in the resource management server creates the command file 801 based on the management database 203. When the server is a relay server, the existence checking processing unit updates the received command file 801 to create a new command file 801. In step 1002, a connection request is sent, via the connection request unit 207, to the terminal immediately following the terminal itself in the destination path. In step 1003, a check is made if a response is received within a predetermined time. If a response is received within a predetermined time, control is passed to step 1004; otherwise, control is passed to step 1007.

In step 1007, the existence checking processing unit assumes that the subordinate terminal is not activated and tries to activate the terminal via the network. To do so, the existence checking processing unit sets the activation request flag in the command file 801 and, in step 1008, sends an activation message via the network. In step 1009, a check if made if a response is received within a predetermined time. If a response is received within the predetermined time, control is passed to step 1004; otherwise, control is passed to step 1010.

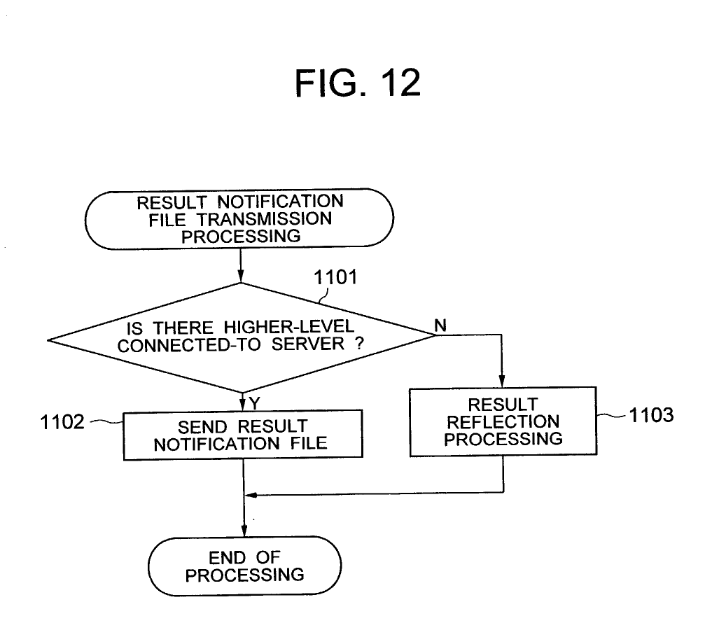

In step 1010, the result notification file 802 is created with the status field set to “no-response to the command file 801”. In step 1004, the command file 801 is sent from the connection request unit 207 to the subordinate terminal and, in step 1005, the result notification file 802 is received from the subordinate terminal. In step 1006, the result notification file 802 created in step 1005 or 1010 is reflected on the management database according to the processing flow in FIG. 12.

FIG. 12 is a flowchart showing the transmission of the result notification file 802 by the existence checking processing unit 205.

First, in step 1101, the existence checking processing unit checks if there is a higher-level server to which this server is to connect. If there is such a server (that is, when the existence checking processing unit is in a relay server), the relay server 105 transfers the result notification file 802 to the higher-level connected-to server via the request processing unit 304 and the server connection unit 302 (1102). If there is no such higher-level server (that is, when the existence checking processing unit is in the resource management server), the resource management server 101 reflects the result on the management database based on the received result notification file 802 according to the flowchart shown in FIG. 12.

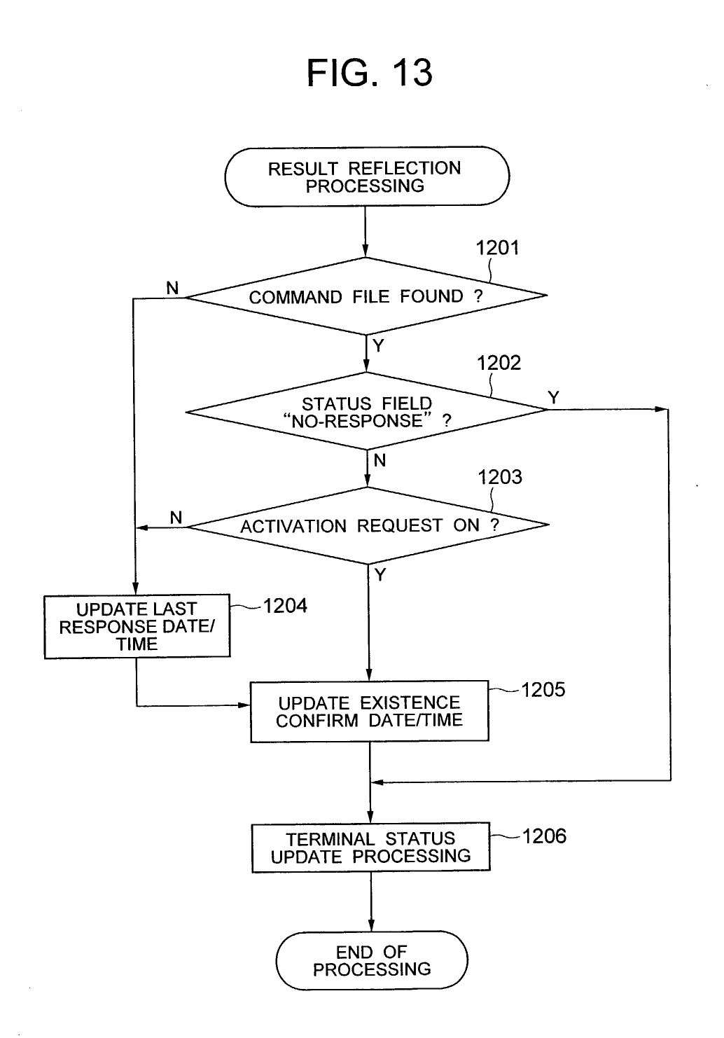

FIG. 13 is a flowchart showing result reflection processing performed by the result reflection processing unit 209. First, in step 1201, the result reflection processing unit checks if there is a command file 801 corresponding to the result notification file 802. If there is no such file, control is passed to step 1204; otherwise, control is passed to step 1202. In step 1204, the result reflection processing unit updates the last response date/time of the terminal that created the result notification file 802 and, in step 1205, updates the existence confirm date/time. In step 1202, the result reflection processing unit 209 checks if the status field of the result notification file 802 contains “no-response”. If the status field does not contain “no-response”, control is passed to step 1203; otherwise, control is passed to step 1206.

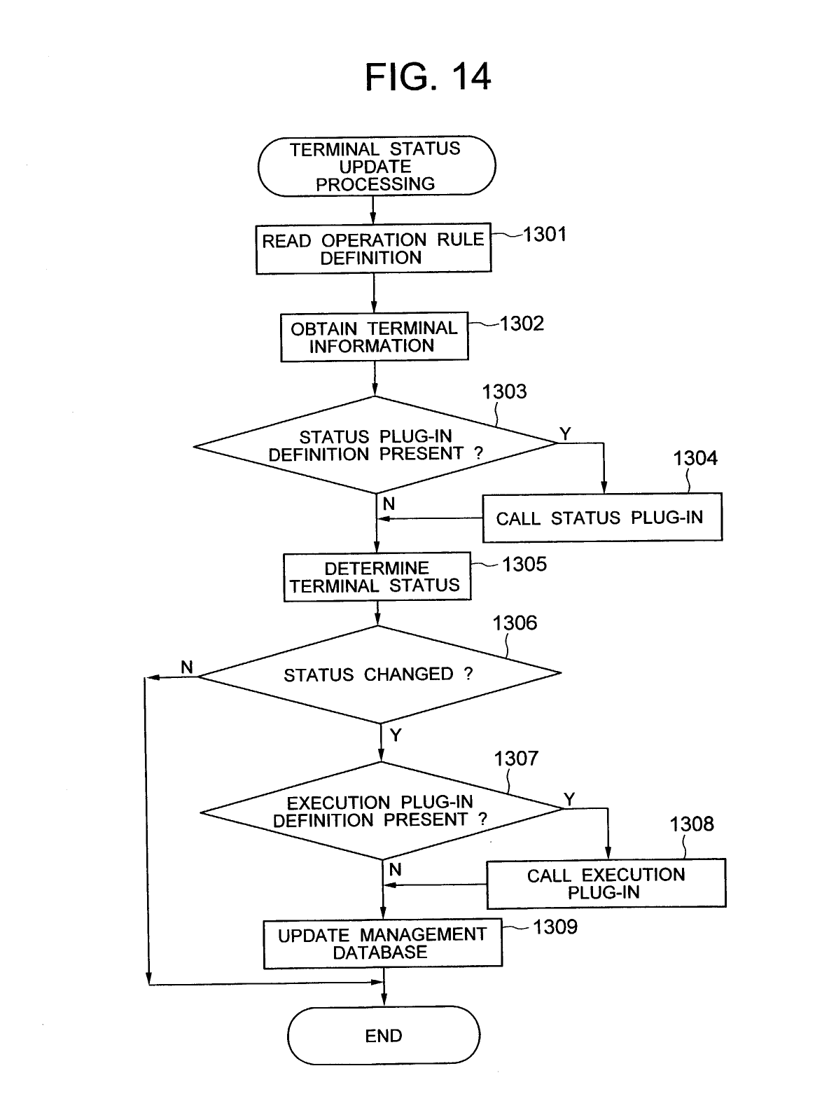

That is, when the status field contains “no-response”, the management database 203 is not updated. In step 1203, the result reflection processing unit checks if the activation request flag is ON. If the activation request flag is not ON, control is passed to step 1204; otherwise, control is passed to step 1205. In step 1205, the existence confirm date/time is updated. In step 1206, terminal status update processing is executed according to the flowchart shown in FIG. 14 and then result reflection processing is terminated.

FIG. 14 is a diagram showing terminal status update processing performed by the terminal status update unit 202. First, in step 1301, the terminal status update unit 202 obtains the status definition information defined in the status definition section 601 of the management rule definition unit. In step 1302, the terminal status update unit obtains information on the terminal from the management database 203. In step 1303, the terminal status update unit checks if the status plug-in definition 604 is defined in the plug-in definition section 603. If it is defined, control is passed to step 1304; otherwise, control is passed to step 1305.

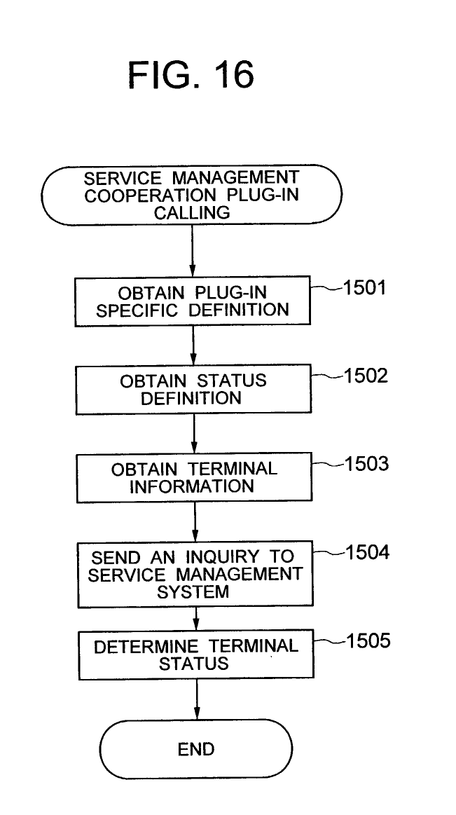

In step 1304, the defined status plug-in is executed according to the flowchart shown in FIG. 16 to obtain the status determined by the status plug-in. In step 1305, a new status is determined based on the status definition information. In step 1306, a check is made if the status has been changed. If the status has been changed, control is passed to step 1307; otherwise the processing is terminated.

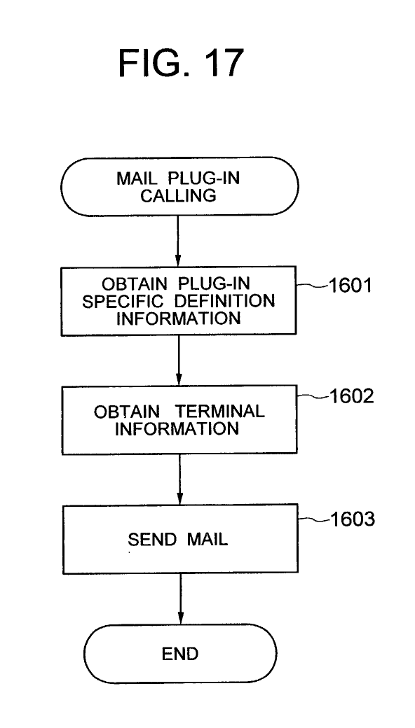

In step 1307, the terminal status update unit checks if whether or not the execution plug-in definition 605 is present. If the execution plug-in definition 605 is defined, control is passed to step 1308; otherwise, control is passed to step 1309. In step 1308, an execution plug-in whose calling condition matches the status determined in step 1305 is called and executed according to the flowchart shown in FIG. 17. In step 1309, the determined status is reflected on the management database and the terminal status update processing is terminated.

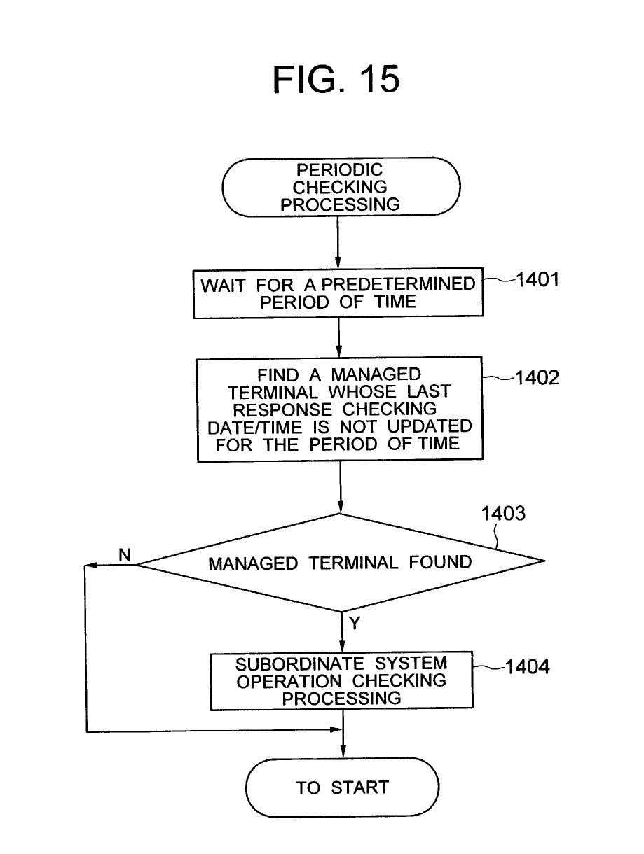

FIG. 15 is a flowchart showing periodic checking processing performed by the time monitor unit 210. In step 1401, the time monitor unit waits for a predetermined period of time and then, in step 1402, searches the management database for a managed terminal that did not respond within that period of time.

If such a managed terminal is found in step 1403, the subordinate system existence checking processing is performed for the managed terminal according to the flowchart shown in FIG. 11. In no such managed terminal is found, processing is terminated. After terminating processing, control is passed to step 1401 and the time monitor unit waits for a predetermined period of time.

FIG. 16 is a diagram showing the processing flow of a service management cooperation plug-in that is an example of status plug-ins. During execution, a status plug-in obtains plug-in specific definition information (step 1501), status definition (step 1502), and target terminal information (step 1503). Then, an inquiry is sent to the service management system (step 1504). Then, the terminal status is determined based on the information (step 1505).

FIG. 17 is a diagram showing the processing flow of a Mail plug-in that is an example of execution plug-ins. During execution, an execution plug-in obtains plug-in specific definition information (step 1601) and target terminal information (step 1602). Next, based on the obtained information, a mail destination and a message are composed and the mail is sent (step 1603).

As described above, the system in this embodiment allows a manager to manage not only in-use managed terminals but also out-of-use terminals and removed terminals. In addition, the system in this embodiment manages the status of out-of-use terminals based on the out-of-use times of out-of-use terminals, enabling the manager to understand the out-of-use times of terminals with no need for the manager to visit the installation locations.

In addition, upon detection of a change in the terminal status, a plug-in is executed to update the management database. This makes it possible to automatically change the terminal operation schedule, make a removal request, or delete terminals from the system configuration information, thus lowering the management cost.

Automatically deleting information on removed terminals from the system configuration reduces both the management database size and the wasteful network traffic required to obtain operation information on out-of-use terminals.

As described above, the system according to the present invention allows a manager terminal to manage managed terminals including out-of-use terminals.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A resource management system using a computer, comprising:
a management database in which management information on a managed terminal connected to a resource management server is stored;
an existence checking processing unit comprising a connection request unit that issues a request to connect to said managed terminal and sends a command file containing an activation request; and a connection acceptance unit that receives a result file containing a response to a command included in the command file; and
a terminal status update unit that updates said management database based on contents notified by the result file.

2. The resource management system according to claim 1, wherein said existence checking unit obtains an out-of-use time of said managed terminal based on monitor information obtained from a time monitor unit.

3. The resource management system according to claim 1, wherein said management server has a plug-in function that checks a status of the managed terminal using another management system.

4. A resource management method using a computer, comprising the steps, by said computer, of:
providing information indicating an operation status of another computer;
sending a first command to said another computer, said first command inquiring whether said another computer is in use;
if no response to the first command is returned from said another computer, sending to said another computer a computer-activation command and a second command inquiring whether said another computer is in use;
checking if there is a response result in response to the second command; and
creating information indicating the operation status of said another computer based on the checking result.

5. The resource management method according to claim 4, wherein the information indicating the operation status of said another computer includes an identifier indicating the computer, an identifier indicating the operation status of the computer, and information indicating a response date/time.

6. The resource management method according to claim 4, wherein the identifier indicating the computer includes one of a computer name, an IP (Internet Protocol) address, and a MAC (Media Access Control) address.

7. A program for managing a computer, comprising the steps of:
sending a connection request to said computer;
checking if a response to the connection request is received from said computer within a predetermined period of time;
sending a computer-activation command to said computer based on the checking result; and
in response to the computer-activation command, creating information indicating an operation status of the computer.

8. The program according to claim 7, wherein the information indicating the operation status of the computer includes an identifier indicating the computer, an identifier indicating the operation status of the computer, and information indicating a response date/time.

9. The program according to claim 7, wherein the identifier indicating the computer includes one of a computer name, an IP address, and a MAC address.
